(19) United States
(12) Patent Application Publication
(10) Pub. No.: US 2010/0010837 A1
(43) Pub. Date: Jan. 14, 2010

(54) SYSTEM AND METHOD FOR USE IN BILLING FOR GROUP BENEFIT INSURANCE

(75) Inventors: Jason Hillyer Lang, Farmington, CT (US); Anthony McGovern, Granby, CT (US)

Correspondence Address: Howard IP Law Group, P.O. Box 226, Fort Washington, PA, 19034, US

(73) Assignee: Hartford Fire Insurance Company, Hartford, CT (US)

(21) Appl. No.: 12/170,235

(22) Filed: Jul. 9, 2008

(51) Int. Cl. G06Q 30/00

(52) U.S. Cl. 705/4

(57) ABSTRACT

A computer system for use in connection with employee benefits furnished via an insurance provider has a processor and a memory in communication with the processor. The processor is adapted to receive input data indicative of a customer identification, a term, one or more types of coverage, a premium amount for the customer for the term and the one or more types of coverage, and one or more conditions relating to premium amount; store the received input data in memory; based on the received input data, generate a bill to the customer, the bill including customer name and address, the premium amount, the term, and the one or more types of coverage; receive a signal having data indicative of a change related to coverage; determine whether the change triggers a change in premium; and if the data is indicative of a change in premium, provide an output signal indicative of a premium change.

### FIELD OF INVENTION

The present invention relates to computer systems, and particularly to computer systems for use in administration of insurance products, particularly group benefit insurance products.

### BACKGROUND

Employers either provide for or arrange for a variety of group insurance benefits for their employees. Typical insurance coverage includes life insurance, disability insurance, short term disability and long term disability. In some cases, the employer provides coverage, with no employee options, and pays an insurer the required premiums. In some cases, an employer offers predetermined coverage to employees, and deducts from the employee's pay each payroll period an amount intended to cover the premiums paid by the employer. The employee may elect to obtain coverage, or additional coverage, and have an amount deducted from pay intended to cover the premium. For example, an employer may offer as a default benefit for all employees life insurance with a certain minimum death benefit, and permit employees to obtain coverage for a higher or lower death benefit through payroll deductions.

In the field of administration of group benefits for employees, two methods of billing to the employer are common. The two methods are referred to as self-administered, and list billing. In self-administered billing, the premium is determined at an aggregate level, based on calculations taking into account each employee and each insurance product applicable to each employee. An insurance company provides the employer, before each premium due date (e.g., monthly) a statement listing the selected coverage, the rates, and estimated amount of premium due based on employee census information previously provided by the employer. The employer is then responsible to calculate the actual premium, by updating the number of insured employees, calculating variables that affect coverage, such as life insurance and accidental death and dismemberment benefit amounts for each employee, weekly benefit amounts for short term disability coverage, covered monthly payroll volume for determining long term disability, identifying changes in employee status, employee terminations and new employees. The administrative burden involved for the employer is substantial. Instructions for calculating the premium amount run to over 20 pages. Errors in reporting information to the coverage provider may not be identified until an audit is conducted; this may result in refunds or make up premiums that are not reflected in payroll deductions.

In list billing, before each premium due date, the employer receives a list bill having a detailed monthly invoice for the employer's group coverage based on employee information previously furnished by the employer. Every covered employee may be listed by name, relevant details such as age bracket, coverage provided, and premium amount. In order for the bill to be accurate, the employer must frequently update the coverage provider with any changes in coverage, employee status, or the like.

In some list billing and self-administered billing arrangements, payroll deductions are intended to cover the cost of premiums. Differences in timing between payroll and premium billing may render the deduction calculation difficulty. For example, premiums may be billed on a calendar month basis, while payroll is often on a biweekly basis.

### SUMMARY OF THE INVENTION

In an embodiment, a computer system includes a processor and a memory in communication with the processor. The processor is adapted to receive input data indicative of a customer identification, a term, one or more types of coverage, a premium amount for the customer for the term and the one or more types of coverage, and one or more thresholds including at least number of employees, and to store the received input data in memory. The processor is further adapted to, based on the received input data, generate a bill for printing and mailing to the customer, the bill displaying customer name and address, the premium amount, the term, and the one or more types of coverage; receive a signal having data indicative of a change in a number of employees; compare the change in number of employees to a threshold; if the change exceeds the threshold, provide an output signal indicative of the exceeding of the threshold, and otherwise, not provide such an output signal.

In one embodiment, a computer system for use in connection with insurance benefits includes a processor and a memory in communication with the processor, the processor adapted to: receive data indicative of receive input data indicative of a customer identification, a term, one or more types of coverage, a formula for a premium based on payroll period, and numbers of employees and corresponding coverage; store the received input data in memory; based on the received input data, generate a bill for printing and mailing to the customer, the bill displaying customer name and address, the premium amount, the term, and the one or more types of coverage; receive a signal having data indicative of a change in an employee coverage election and a change in premium amount based on the formula; based on the received change, determining an updated premium having a changed amount equal to the increase or decrease in payroll deduction of the employee, storing the updated premium, and storing updates to coverage.

In an embodiment, a computer system for use in connection with administration of employee benefits has a processor and a memory in communication with the processor. The processor is adapted to: receive input data indicative of a customer identification, a term, one or more types of coverage, a premium amount for the customer for the coverage for the term, and one or more thresholds including at least number of employees; store the received input data in memory; based on the received input data, generate a bill to the customer, the bill including customer name and address, the premium amount, the term, and the one or more types of coverage; receive a signal having data indicative of a change related to coverage; determining whether the change triggers a change in premium; and if the data is indicative of a change in premium, providing an output signal indicative of a premium change.

In an embodiment, a computer implemented method for use in connection with administration of employee benefits includes receiving input data indicative of a customer identification, a term, one or more types of coverage, a premium amount for the customer for the term and the one or more types of coverage, and one or more thresholds including at least number of employees; storing the received input data in memory; based on the received input data, generating a bill to the customer, the bill including customer name and address, the premium amount, the term, and the one or more types of coverage; receiving a signal having data indicative of a change related to coverage; determining whether the change triggers a change in premium; and if the data is indicative of a change in premium, providing an output signal indicative of a premium change.

In an embodiment, a computer-readable medium has instructions thereon which, when executed by a processor, cause the processor to perform the steps of: receiving input data indicative of a customer identification, a term, one or more types of coverage, a premium amount for the customer for the term and the one or more types of coverage, and one or more thresholds including at least number of employees; storing the received input data in memory; based on the received input data, generating a bill to the customer, the bill including customer name and address, the premium amount, the term, and the one or more types of coverage; receiving a signal having data indicative of a change related to coverage; determining, based on at least one of the thresholds, whether the change triggers a change in premium; and if the data is indicative of a change in premium, providing an output signal indicative of a premium change.

### BRIEF DESCRIPTION OF THE DRAWINGS

FIG. 1 is a schematic diagram of an exemplary computer system for implementation of a method and system of the invention.

FIG. 2 is a schematic diagram of an arrangement of client computers and a server computer for implementation of a method and system of the invention.

FIG. 3 is a process flow diagram illustrating an implementation of the invention in the form of a method for use in connection with administration of employee benefits.

FIG. 4 is a process flow diagram illustrating a method for use in connection with administration of employer-paid employee benefits.

FIG. 5 is a process flow diagram illustrating a method for use in connection with administration of employee-paid benefits.

### DETAILED DESCRIPTION

It is to be understood that the figures and descriptions of the present invention have been simplified to illustrate elements that are relevant for a clear understanding of the present invention, while eliminating, for the purpose of clarity, many other elements found in typical computer systems, methods for administration of insurance products such as employee benefits. Those of ordinary skill in the art may recognize that other elements and/or steps are desirable and/or required in implementing the present invention. However, because such elements and steps are well known in the art, and because they do not facilitate a better understanding of the present invention, a discussion of such elements and steps is not provided herein.

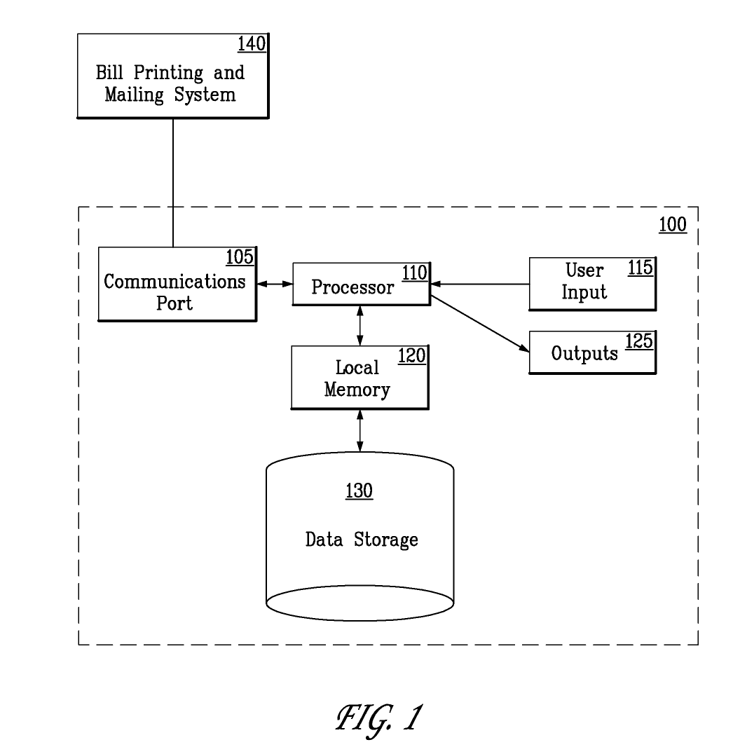

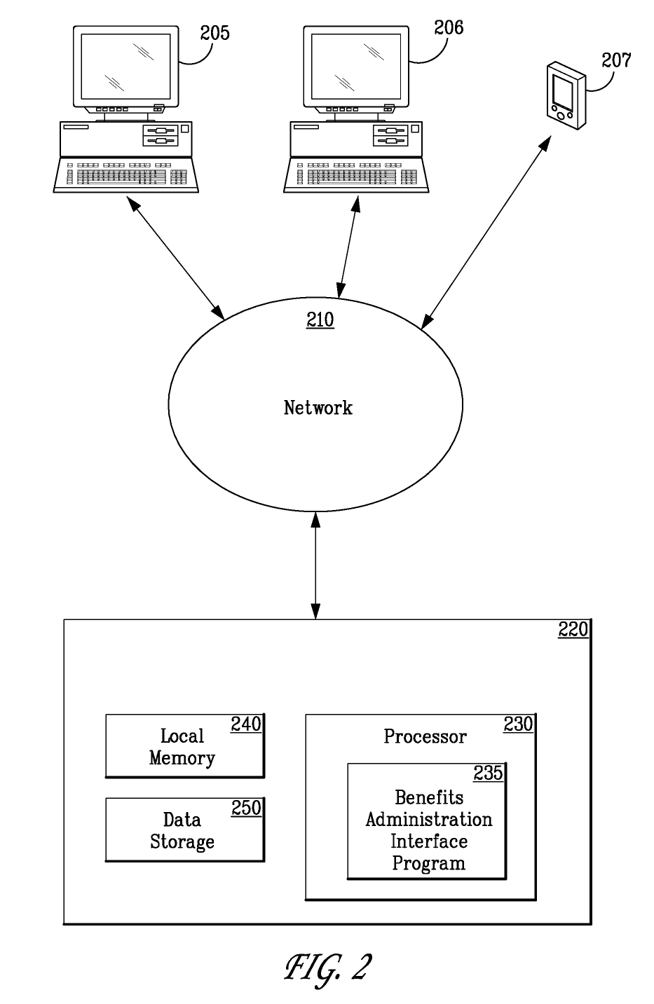

Referring to FIG. 1, an exemplary computer system for use in the implementation of the invention will now be described. In computer system 100, processor 110 executes instructions contained in programs stored on recorded media. Processor 110 communicates, such as through suitable buses and other data channels, with communications port 105 and local memory 120, receives data from user inputs 115, and provides data to outputs 125. Local memory 120 is configured to exchange data with processor 110, and may store programs containing processor-executable instructions, and values of variables for use by such programs. Data storage 130 may include a wide variety of data acquired and processed in accordance with the invention. User input may be provided at inputs 115, which may include keyboards, mice and touchscreens. Outputs 125 may include displays and printers. Communications port 105 communicates with remote devices, that may include sources of information, third party computer systems, such as banking system, and systems dedicated to particular tasks, such as tasks related to generation of bills. Communication may be by one or more of suitable communication methods, including over wired or wireless local area networks and wide area networks, and over communications between networks, including over the Internet. Any suitable data and communication protocols may be employed. In the example of FIG. 1, system 100 communicates with a bill printing and mailing system 140. Bill printing and mailing system 140 may include one or more computer systems, including processors, memory devices, user inputs, outputs, software executed by the processors, and other conventional components. Bill printing and mailing system 140 may be adapted to receive an output signal via communications port 105, which output signal includes information for inclusion in a printed bill, including name and address of customer, a term for the insurance, a listing of products and services provided, a premium amount, and other information. System 140 may include in particular one or more printers, and may include other devices useful in printing and mailing paper bills, such as devices for feeding paper, separating printed bills from one another, inserting printed bills into envelopes, sealing envelopes, and applying postage to envelopes as appropriate. The printed bill is then mailed to the customer. In an embodiment, system 140 may be replaced or supplemented by a secure web server that permits users from client devices, after providing login information, to view bills and statements, as discussed in greater detail with reference to FIG. 2.

A challenge that has been recognized by the inventors is that of reducing the complexity to the customer of determining premium payments. In self-administered billing, the amount of the premium is generally determined retrospectively based on details of number of employees, ages, selected insurance products, and other factors. The customer must collect and transmit to the insurance provider all of this information. The administrative burden is substantial. Interim premium payments are merely estimated, and retrospective changes occur. The customer/employer may face an unexpected additional premium payment after recalculation of an estimated bill. In list billing, it may be difficult for the employer to match premium payments made, for example, on a calendar month basis, with payroll deductions on different basis, such as biweekly.

FIG. 2 is a schematic diagram of a client server arrangement for implementation of a method and system in accordance with an embodiment of the invention. In the arrangement of FIG. 2, client devices 205, 206, 207 may be connected via network 210 to server 220. Server 220 may be operated by or on behalf of an insurance services provider, such as an insurance company; client devices 205, 206, 207 may be operated by users, such as personnel of an employer. In an implementation, client devices 205, 206, 207 may be personal computers running an operating system such as Windows XP, Windows Vista, or Apple Tiger, thin client devices, portable devices such as personal digital assistants (running the Palm OS, by way of example), cell phones, or other devices. Network 210 may be or include the Internet, a corporate intranet, wireless and wired communications channels, and other network features. Server 220 may include processor 230 having local memory 240 and data storage 250. Benefits administration interface program 235 runs on processor 230. Benefits administration interface program 235 may initiate sessions with one more of client devices 205, 206, 207. Benefits administration interface program 235 may provide secure login, access to premium information, and provide for customer representatives to update information on such information as coverage elections, numbers of employees, employee demographics, and the like. Benefits administration program 235 may be, by way of example only, a Java-based program.

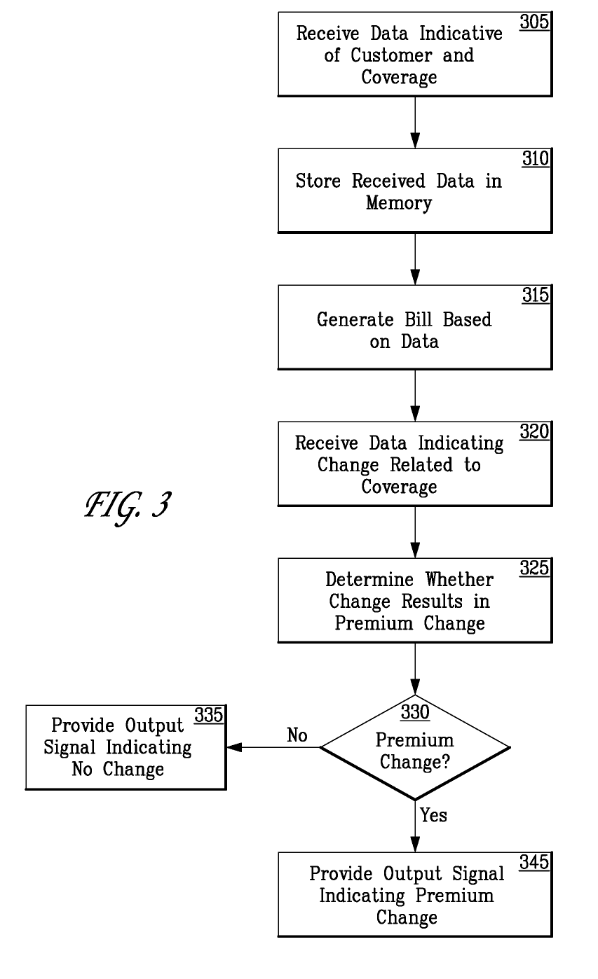

Referring now to FIG. 3, a method in accordance with an embodiment of the invention will now be described. This method may be implemented by a computer system, such as the computer system illustrated in FIG. 1. Processor 110 may receive data 305 indicative of information related to a policy, such as customer identification, a term, one or more types of coverage, a premium amount for the customer for the term and the one or more types of coverage, and one or more thresholds including at least number of employees. The data may be received as digital signals from a local or networked user input, for example, or may be transferred as one or more files from another device or system.

The received data may be stored 310 in memory in suitable storage locations by the processor. For example, the stored data may be stored in a suitable database format.

Based on the received input data, the processor may generate 315 a bill for forwarding to the customer. The processor may load a suitable bill generation program, access data from memory as indicated by the bill generation program, and generate the bill. Generation of the bill may include formatting a bill into a print file for transmission to a printer, by way of example, generation of an image file, such as a pdf or tiff format file, delivery to another system, or generation of another document for forwarding. In an embodiment, the processor may cause a digital signal having data indicative of the bill to bill printing and mailing system 140. The bill may include the customer name and address, the premium amount, the term, and the one or more types of coverage included. The premium amount is fixed.

The processor may receive 320 a signal including data indicative of a change related to coverage. The data may include a change in the number of employees, a change in the coverage of employees, or another change. The processor may then determine 325 whether the change triggers a change in premium. The processor may do so by retrieving a suitable algorithm from memory and inputting the changed data. By way of example, if a billing arrangement in connection with an embodiment of the invention calls for a flat bill that does not change unless certain threshold changes occur, an algorithm for use in connection with determining whether a premium is to be changed may include threshold values. For example, a change in the number of employees may only result in a change in premium if the change is at least a floor percentage or number change. The change may be either an increase or a decrease. By way of further example, if the billing arrangement in accordance with another embodiment of the invention is for voluntary choices by employees to change coverage, then any change initiated by an employee may result in a change in premium.

If the data is indicative of a change in premium 330, the processor may provide an output signal indicative of a premium change 345. The output signal may result in a message being displayed on a user-accessible device, such as an output 125 of FIG. 1, or one of the devices 205, 206, 207 of FIG. 2. The output signal may also be provided to a bill printing and mailing system 140 for printing and mailing of a new bill. Depending on the time in a billing cycle that the data is received, the new bill may be for a future billing period, such as the next month, or may replace a bill that has already been printed and mailed. If the data is not indicative of a change in premium, the processor may provide an output signal indicative of no change 335.

The processor may receive a signal having data indicating that payment in the amount of the bill has been received. For example, the signal may be input from a local input, or may be received from a computer system dedicated to receiving and processing payment information. When the signal indicating that payment in the amount of the bill has been received, the records are updated to indicate that the premium for the period has been paid in full. The premium is reflected as paid in full even if the premium has not been calculated for that period based upon a precise employee census.

It will be noted that, in prior art self-administered billing systems, receipt of payment in the amount of the estimated bill does not indicate that the premium obligation has been satisfied. In prior art self-administered billing systems, the employer calculates an estimated amount, which may be later changed as the result of corrections or an audit.

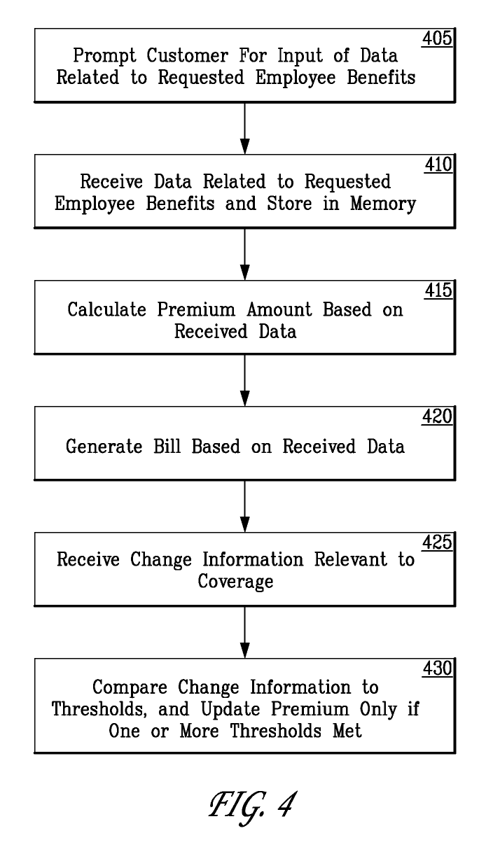

Referring to FIG. 4, a process flow will be described of an embodiment in which administration of mandatory benefits is provided. In this embodiment, an employer has been prompted 405, such as by a screen prompt on a web-based tool operated on behalf of a group benefits provider, such as an insurance company, for data related to mandatory benefits. The data may be provided via a client server connection, such as in the example of FIG. 2. The program of FIG. 2 may provide one or more forms for transmission of relevant data. The relevant data may include any data that would be of interest to a group benefits provider in determining a premium amount. The data may include: name and address of the employer; a term of the coverage, such as a one year term commencing on a certain date; number of employees to be covered; type of business of the employer; job descriptions of the employees to be covered, such as clerical, manufacturing, warehouse, or other more detailed descriptions; dependent information of the employees; ages of the employees to be covered, which may be precise, or providing a census for a selection of age bands, such as five year age bands; salary or wages of the employees, which may be provided precisely or according to a census in bands. The desired coverage must be provided. Exemplary types of coverage include life insurance, short-term disability insurance (STD), long-term disability insurance (LTD), accidental death and dismemberment insurance (AD&D). Coverage amounts must be provided. For life insurance, amounts may be flat per employee, or may be based on a formula, such as a formula linked to a weekly, monthly or other period wage. Life insurance coverage may be based on a formula based in part on age, such as a phased decrease over an age range, e.g., from 65 to 70. For short-term disability and long-term disability, benefits may be a percentage of a monthly or weekly wage or salary.

The processor receives the data 410 and may cause the data to be stored in memory. An operator at the benefits provider may access the information, review it for completeness and accuracy, and direct any follow up inquiries to the customer. The operator may obtain access locally, as in the embodiment of FIG. 1, or remotely via a client-server application over the Internet or a local intranet, as shown in FIG. 2. The processor may load a single-purpose program for display of the information, or may provide the information in a database application or spreadsheet application, by way of example. The operator may provide instructions for changing of the data, such as to correct errors, or after obtaining updated or additional data from the customer.

In an implementation, the premium and other terms may be calculated 415. Alternatively, premium and other terms may be received from an input device, or transmitted from another file. Calculation of the premium may involve obtaining formulas for each individual, and applying each formula to the demographic data for each individual, summing the results of those calculations, and then applying an additional formula, if applicable, to reflect underwriting analysis. The calculated or received premium may be stored in memory.

One or more data points may be provided, where a change in excess of a threshold triggers a recalculation of the premium. A change in excess of a threshold serves the purpose of triggering an output signal for initiation of a review of the premium. The review of the premium may be carried out by suitable software, or by an operator accessing the data, or by a combination thereof. The data points may include number of employees; a threshold may be, for example, a percentage, such as 5%, 10% or 15%, increase or decrease in full time equivalent employees. The data points may include number or percentage of employees in a particular occupational category; a threshold may be a change of more than 5% in the percentage of factory employees. The data points may also include a median or average age of employees.

A bill may be generated indicating the premium amount, term, and coverage 420. The bill may include a listing of one or more data points and thresholds.

The processor may receive information related to a change in one or more data points 425. For example, the employer's number of employees may have changed.

In an embodiment of the invention, absent a change in one or more of the data points beyond a threshold, the premium will not be reviewed or recalculated and will remain unchanged for the entire term. The lack of change in premium amount, despite changes in such data points as number of employees, types of positions, and ages of employees, contrasts with the prior art. In the prior art, the premium is recalculated with every change in a data point. Moreover, a method of the invention, unlike prior art techniques, does not require the employer to submit detailed information on an ongoing or periodic basis so that the premium can be recalculated. The administrative burden on the employer is thus reduced compared to the prior art. In addition, the premium amount is predictable for the employer.

After comparing received information to the threshold data points, the processor may provide an output signal 430 indicating a premium change, if one or more thresholds are exceeded, or no premium change, if no threshold is exceeded. The output signal may also be in the form of an alert to an operator.

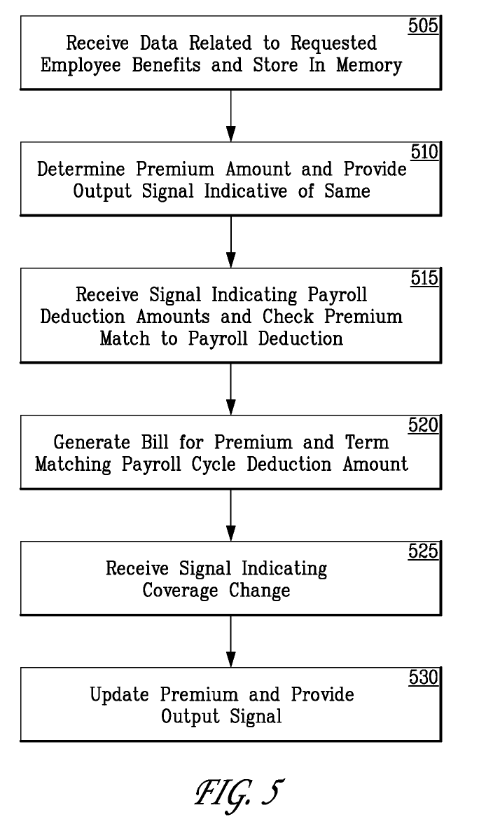

Referring to FIG. 5, a process flow of an implementation of the invention for processing of employee paid coverage is illustrated. In this implementation, the amount of the employer's payroll deduction is equal to the premium. The employer provides requested information at the beginning of a term, such as a year term. The data is received by a processor, and stored in memory 505. The premium is then determined, and an output signal indicative of the premium amount is provided 510. The premium amounts may be calculated on an employee by employee basis per payroll period, and provided as an output signal. The premium due dates may be coordinated with a received payroll schedule. In an embodiment, the processor may receive signal indicative of the amount that the employer plans to deduct by payroll deduction, check the premium amount against the payroll deduction amount 515, and provide an output signal indicative of whether the premium amount matches the intended payroll deduction. If the output indicates a match, then the premium amount for the bill need not be adjusted. If the output indicates a discrepancy, then either the payroll deduction amount or the premium amount is incorrect. An output signal may provide an alert for an operator to check. In an embodiment, a contact avenue for the customer, such as a postal address, an e-mail address, or an account available over the web via a secure server connection, for example, may be checked, and a signal provided to create an electronic message, or to print and send a postal notification, of the discrepancy. An updated payroll deduction amount may then be received and checked again, until the premium amount and payroll deduction amount are consistent.

Based on the premium amount and other data, a bill may be generated 520 to the customer. The amount and term of the bill may be consistent with the employer's payroll cycle and deduction amounts. As described above, the bill may be generated by providing an output signal to a bill printing and mailing system, such as bill printing and mailing system 140 of FIG. 1.

A signal may be received 525 having data indicative of a change related to coverage. For example, an existing employee may have elected to add optional coverage, such as life insurance, to change an amount of coverage, such as life insurance coverage, or to drop an optional coverage. An employee's status may have changed, such as by change in salary, resulting in a change in a calculated coverage and premium amount. Any other change in coverage, or requested change in coverage, may be included in the data. The signal may include data indicative of the employer's calculated change in payroll.

In response to the signal, the processor may determine an updated premium, and provide an output signal indicating the updated premium 530. The updated premium may be compared to the updated payroll deduction amount, and, as described above, an output signal may trigger a notification to the employer and/or to an operator of a discrepancy.

An advantage of an implementation of the invention as illustrated in FIG. 5 is that calculation of the premium based on payroll periods results in a match between payroll deductions and premium amounts.

The present invention is operable with computer storage products or computer readable media that contain program code for causing a processor to perform the various computer-implemented operations. The computer-readable medium is any data storage device that can store data which can thereafter be read by a computer system such as a microprocessor. The media and program code may be those specially designed and constructed for the purposes of the present invention, or they may be of the kind well known to those of ordinary skill in the computer software arts. Examples of computer-readable media include, but are not limited to magnetic media such as hard disks, floppy disks, and magnetic tape; optical media such as CD-ROM disks; magneto-optical media; and specially configured hardware devices such as application-specific integrated circuits (ASICs), programmable logic devices (PLDs), and ROM and RAM devices. Examples of program code include both machine code, as produced, for example, by a compiler, or files containing higher-level code that may be executed using an interpreter. Steps in the computer-implemented methods may be implemented in processors running software stored locally, and/or in configurations such as application service providers, in which certain steps are executed on processors communicating with one another over a network such as the Internet. Either stand-alone computers or client/server systems, or any combination thereof, may be employed.

A system in accordance with the invention may include means corresponding to each step in any of the methods described in this application. Each of the means may be implemented by a processor, such as processor 110, executing instructions contained in programs which may be stored in a storage medium, such as local memory 120. It will be appreciated that any of the steps in the methods in accordance with the invention described herein may be so implemented.

It will be appreciated that references to numbers of employees herein may include total numbers of employees and/or numbers of employees eligible for particular types of benefits. By way of example, employees may be eligible for certain types of benefits only based on certain conditions, such as a minimum number of hours per pay period, or a certain period of continuous employment.

It will be appreciated that advantages of a method and system in accordance with the present invention include reduction of administrative burden for customers and greater certainty in the amount of premiums for coverage.

While the foregoing invention has been described with reference to the above embodiments, various modifications and changes can be made without departing from the spirit of the invention. Accordingly, all such modifications and changes are considered to be within the scope of the appended claims.

What is claimed is:

1. A computer system for use in connection with administration of employer-paid employee benefit insurance products; comprising:
a processor; and
a memory in communication with the processor;
the processor adapted to:
receive input data indicative of a customer identification, a term, one or more types of coverage, a premium amount for the customer for the term and the one or more types of coverage, and one or more thresholds including at least number of employees;
store the received input data in memory;
based on the received input data, generate a bill for printing and mailing to the customer, the bill displaying customer name and address, the premium amount, the term, and the one or more types of coverage;
receive a signal having data indicative of a change in a number of employees;
compare the change in number of employees to a threshold;
if the change exceeds the threshold, provide an output signal indicative of the exceeding of the threshold, and otherwise, not provide such an output signal.

2. The system of claim 1, wherein the term is a year, and the processor is further adapted to generate monthly bills.

3. The computer system of claim 1, wherein the processor is further adapted to present on a display at an insurance company computer an alert to recalculate the premium in response to exceeding the threshold.

4. A computer system for use in connection with administration of employee paid employee benefit insurance products, comprising:
a processor; and
a memory in communication with the processor;
the processor adapted to:
receive input data indicative of a customer identification, a term, one or more types of coverage, a formula for a premium based on payroll period, and numbers of employees and corresponding coverage;
store the received input data in memory;
based on the received input data, generate a bill for printing and mailing to the customer, the bill displaying customer name and address, the premium amount, the term, and the one or more types of coverage;
receive a signal having data indicative of a change in an employee coverage election;
based on the received change, determine an updated premium having a changed amount equal to the increase or decrease in payroll deduction of the employee, store the updated premium, store updates to coverage, and provide an output signal indicative of the updated premium.

5. The system of claim 4, wherein the change in an employee coverage election is an addition to coverage, and the change in premium amount is an increase.

6. The system of claim 4, wherein the change in an employee coverage election is a deletion of a coverage, and the change in premium amount is a decrease.

7. The system of claim 4, wherein a premium bill amount for a time period is equal to an employer payroll deduction amount for the time period.

8. A computer system for use in connection with employee benefits furnished via an insurance provider, comprising:
a processor;
a memory in communication with the processor;
the processor adapted to:
receive input data indicative of a customer identification, a term, one or more types of coverage, a premium amount for the customer for the coverage for the term, and one or more thresholds including at least number of employees;
store the received input data in memory;
based on the received input data, generate a bill to the customer, the bill including customer name and address, the premium amount, the term, and the one or more types of coverage;
receive a signal having data indicative of a change related to coverage;
determining whether the change triggers a change in premium; and
if the data is indicative of a change in premium, providing an output signal indicative of a premium change.

9. The system of claim 8, further comprising a user-accessible device, the processor being adapted to receive the data from the user-accessible device.

10. The system of claim 9, wherein the processor is further adapted to prompt via the user-accessible device for data relevant to premium calculation.

11. The system of claim 8, further comprising: a bill printing system having a processor for: receiving an output signal having data indicative of bill information, and for printing and mailing a bill based on the received data.

12. A computer implemented method for use in connection with administration of employee benefits, comprising:
receiving input data indicative of a customer identification, a term, one or more types of coverage, a premium amount for the customer for the term and the one or more types of coverage, and one or more thresholds including at least number of employees;
storing the received input data in memory;
based on the received input data, generating a bill to the customer, the bill including customer name and address, the premium amount, the term, and the one or more types of coverage;
receiving a signal having data indicative of a change related to coverage;
determining whether the change triggers a change in premium; and
if the data is indicative of a change in premium, providing an output signal indicative of a premium change.

13. The method of claim 12, wherein the step of receiving data comprises receiving data from a memory.

14. The method of claim 12, wherein the step of receiving data comprises receiving data from a user-accessible device.

15. A computer-readable medium having a plurality of instructions thereon which, when executed by a processor, cause the processor to perform the steps of:
receiving input data indicative of a customer identification, a term, one or more types of coverage, a premium amount for the customer for the term and the one or more types of coverage, and one or more thresholds including at least number of employees;
storing the received input data in memory;
based on the received input data, generating a bill to the customer, the bill including customer name and address, the premium amount, the term, and the one or more types of coverage;
receiving a signal having data indicative of a change related to coverage;
determining, based on at least one of the thresholds, whether the change triggers a change in premium; and
if the data is indicative of a change in premium, providing an output signal indicative of a premium change.

16. The computer-readable medium of claim 15, wherein the premium amount is equal to a payroll deduction amount.

17. The computer-readable medium of claim 15, wherein the thresholds further include employee status information.
